(19) United States
(12) Patent Application Publication
(10) Pub. No.: US 2024/0212405 A1
(43) Pub. Date: Jun. 27, 2024

(54) MEANS OF POWERING SMART LOCK AND SIMILAR SYSTEMS

(71) Applicants: Hari Atkuri, Minnetonka, MN (US); Benjamin Arthur Jayson, Moutain Lakes, NJ (US); Vassili Sergan, Carmichael, CA (US)

(72) Inventors: Hari Atkuri, Minnetonka, MN (US); Benjamin Arthur Jayson, Moutain Lakes, NJ (US); Vassili Sergan, Carmichael, CA (US)

(21) Appl. No.: 18/342,110

(22) Filed: Jun. 27, 2023

Related U.S. Application Data
(60) Provisional application No. 63/434,934, filed on Dec. 22, 2022.

(51) Int. Cl. G07C 9/00

(52) U.S. Cl. CPC G07C 9/00563; G07C 2009/00642

(57) ABSTRACT

A smart lock system comprising a glass panel having the smart lock and a plurality of conducting interlayers embedded in a glass to power the smart lock, wherein at least two conductive interlayer selected from the plurality of conducting interlayers are electrically isolated and utilized as electrical conduits to supply power to the smart lock. The pluralities of conducting interlayers are the transparent conducting interlayers. The smart lock system comprises a communication network is configured to transmit and receive the data collected to a remote server or a cloud and an artificial intelligence based neural network is embedded in the smart lock, to collect the usage pattern and utilized it for training and enable remote access. The glass panel is selected from a door, a moving partition, a wall, a flat or a curved component, a window, a balustrade, a railing, a room divider, a curtain wall, a storefront, a skylight, a façade or a ceiling.

### CROSS-REFERENCE TO RELATED APPLICATIONS

This application claims the benefit of the filing date of U.S. Provisional Application Ser. No. 63/434,934 titled “A means of remote powering smart lock and similar systems” and filed Dec. 22, 2022 and the subject matter of which is incorporated herein by reference

### TECHNICAL FIELD

The present invention relates to glass and most particularly related to embedded electronics in the glass for electrical conductivity through the glass.

### BACKGROUND

The following description includes information that may be useful in understanding the present invention. It is not an admission that any of the information provided herein is prior art or relevant to the presently claimed invention, or that any publication specifically or implicitly referenced is prior art.

Slim and sleek designs are often the most desired aspects of the electronics-based hardware used in glass doors and windows. Now a days, the current size of electronics-based smart locks, sensors and similar systems used in combination with glass are less attractive and “often” bulky and huge and could further be improved by means of reducing the size of the electronics-based hardware products such as locks and sensors and such hardware systems.

Currently, many of the electronics-based hardware and similar attachments to glass and glass-like products such as doors and windows are large and relatively bulky. This makes the doors and windows look less sleek and not appealing to the customers and contractors and commercial builders.

There is a need for slim and sleek embedded electronics and electronics hardware such as smart lock for glass and glass like products. Further, a product having as much as electronics and power supply and power sources outside the product itself and out of one's view is beneficial to make any glass and related products with electronics hardware look aesthetically better.

### SUMMARY OF THE INVENTION

In view of the above-mentioned shortcomings mentioned in the prior art or background, the purpose of the present invention is to provide an innovative solution to the current problem mentioned in the background.

The present invention relates to glass and most particularly related to embedded electronics in the glass for electrical conductivity through the glass. It could be glass, or the definition of glass should include all products but not limited to the products, such as acrylic, polycarbonate, laminated glass and tempered glass, etc. Further, the application can find its application in the field of residential, commercial, automotive, avionics, hospitals (medical facilities), trains, marine, construction, energy, and industrial use.

The invention related to reduction of the size of the electronics-based hardware integrated within the hardware that is immediately attached to the glass. A few examples for such electronics-based hardware are smart locks, related apparatus, sensors, and similar systems.

The desired smaller size for the electronics-based hardware is achieved by strategically realizing the power source and related hardware, sensors and electronics external to the desired glass hardware. The transparent electrically conducting interlayers embedded in the glass is used as a power conduit/s for powering the electronics-based hardware or similar systems and sensors.

By embedding the electronics into the glass and by using the transparent or semi-transparent electrically conductive interlayers, this will reduce the size of the electronics and power sources and the enclosing hardware looks smaller and sleeker.

The number of interlayers and electrical-channels or pathways could be more than one embedded in the glass used as communication pathways and or as a power conduit/s to power the hardware such as smart locks attached to the glass product and other electronics-based hardware or similar systems and sensors.

The summary of the invention does not necessarily disclose all the features essential for defining the invention. The invention may reside in a sub-combination of the disclosed features. The various combination and sub-combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a systematic view of a smart door, in accordance with a preferred embodiment of the invention.

FIG. 2 illustrates another glass door having embedded smart lock, in accordance with a preferred embodiment of the invention.

FIG. 3 illustrates the positive and negative terminal of the connections, in accordance with a preferred embodiment of the invention.

FIG. 4 illustrates the electrically conducting contacts on the top glass door hinges, in accordance with the preferred embodiment of the invention.

FIG. 5 illustrates the electrically conducting contacts on the bottom glass door hinges, in accordance with the preferred embodiment of the invention.

FIG. 6 illustrate the electrical isolation of the glass conductive layer, in accordance with the preferred embodiment of the invention.

FIG. 7 illustrates the smart lock connected or embedded to the glass panels, in accordance with the preferred embodiment of the invention.

### DETAILED DESCRIPTION OF DRAWINGS

To make the objectives, technical solutions, and advantages of this application clearer, the following clearly and completely describes the technical solutions in this application with reference to accompanying drawings in this application. Obviously, described embodiments are a part rather than all of embodiments of this application. All other embodiments obtained by a person of ordinary skill in the art based on embodiments of this application without creative efforts shall fall within the protection scope of this application.

Various terms as used herein are shown below. To the extent a term used, it should be given the broadest definition persons in the pertinent art have given that term as reflected in printed publications and issued patents at the time of filing.

A smart lock system comprising a glass panel having the smart lock; a plurality of conducting interlayers embedded in a glass to power the smart lock, wherein at least one conductive interlayer selected from the plurality of conducting interlayers are electrically isolated and utilized as electrical conduits to supply power or some sort of communicating signals for the applications that are not just limited to supplying power to the smart lock.

The glass used for door hardware embeds at least one electrically conductive inter layer. At least two electrically isolated conductive interlayers (014, 015) used as electrical conduits to power the smart lock and or similar electronics-based hardware system(s).

A typical glass (013) used in current smart lock powered configuration. This type of glass does not necessarily use an electrically conducting layer or layers on a glass as the smart lock does not necessarily use external electrical conduits as a means to powering the smart lock or similar hardware.

Using external power source (004) and isolated electrically conducive interlayers (014, 015) of the glass as electrical channels to help power the smart locks (018, 020) remotely. This helps reduce the hardware footprint making (019, 020) smaller on the glass hardware resulting in more presentable low foot-print hardware 018 on the glass.

Adapt (007, 008, 009, 010, 011, and 012) are hinges to support the glass structure, conducting contacts, and contacts such as solder material to the conducting layer of the glass.

There are various steps for preparation of smart glass. These various steps are:
1. Select a glass used for glass hardware such as doors, storefronts and moving partitions etc. with electrically conducting internal layer or layers. As needed, make sure the glass always has enough topcoat or hard coat protection that is scratch resistant and useful in addressing various safety concerns.
2. Electrically isolate the electrically conducting internal layer or layers of the glass based on the required number of electrical connections to successfully operate the electrical smart lock, sensors, communication or similar hardware systems. The electrical connection of metal to glass through a specialized and proprietary equipment and process.
3. Arrange the electrical connections thru the isolated electrical layers. There may be sensors in place to detect and communicate any compromised or damaged inner layers.
4. Make appropriate connections from the lock terminals to the terminals of the power supply and sensor or related electronics and electrical circuits that are external to the glass door.
5. The product is operational, and the footprint of the smart lock hardware is much smaller as a result.

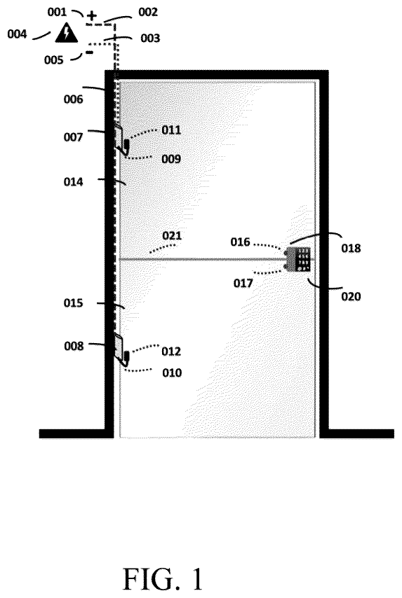

FIG. 1 illustrates a systematic view of a smart door, in accordance with a preferred embodiment of the invention. A glass door or window frame (006) of glass or similar substrate (013) having top hinge (007) and bottom hinge (008) is embedded with a smart lock with integrated or internal power source (019). The glass or similar substrate is coated or printed or applied or treated with an isolated or inner conductive layer (014).

A keypad (020) is connected to the smart lock. The keypad is used to enter the access code to lock/unlock the smart lock. The smart lock may also have a fingerprint sensor or biometric sensor to provide authorization to the requesting user based on the biometrics, which are pre-stored in a database or may offer to store afresh for a new and credible user.

The electrical terminals (016, 017) are at least the first and second of the two electrical terminal to powering the smart lock (018). The positive electrical terminal (001) and negative electrical terminal (005), receives external power from an external power source (004). The received power from positive and negative terminal is communicated via wires (002, 003) connecting to these positive and negative power source to the top hinge contact and bottom hinge contact. The terminals could also be presented as live and neutral that still provide the required potential difference or power to the target hardware. In other words, the same electrical terminals could be ground and reference to provide the necessary potential difference.

The glass act as conduit for transferring the current, voltage, and thus the necessary power or electricity through the hinges to the smart lock terminals.

The smart glass needs at least two isolated electrical connections. Any additional electrical connection through the glass as electrical conduit are optional and fully depends on the need of the power requirements of the smart lock or associated sensors or similar hardware systems. Such additional isolated electrical connections can be helpful for sensor powering etc.

The smart lock system further comprises a communication system to transmit and receive the data to and from the smart lock to a remote server or a cloud or simply work with a local edge computing.

The smart lock system further comprises an artificial intelligence based neural network to identify the usage patterns of the smart lock, The usage pattern identified by the data is then utilized to the train the artificial network.

The smart lock system utilizes the usage pattern and the communication system to enable remote access or operation of the smart lock.

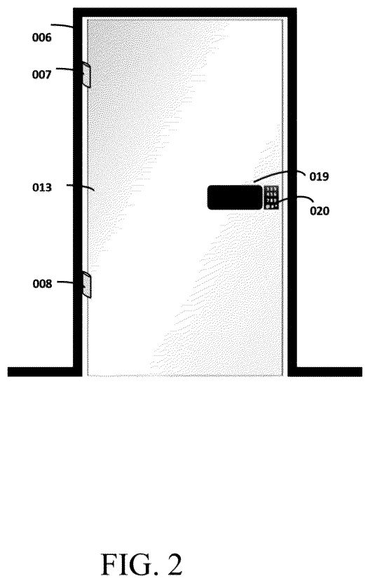

FIG. 2 illustrates another glass door having embedded smart lock, having door or window frame. The glass or similar substrate is attached to the frame through a single hinge system (not shown) or top and bottom hinges as shown. The hinges also serve as a contact point from receiving current, and voltage and thus power from the external power source through wires connecting to the external power source.

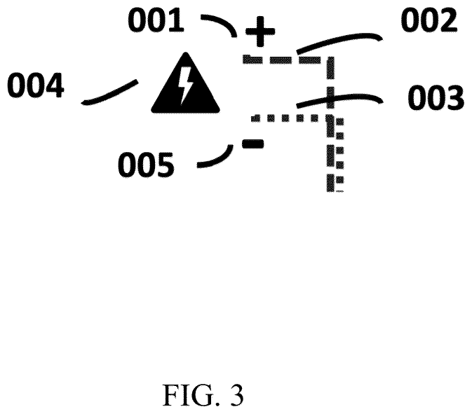

FIG. 3 illustrates the positive and negative terminals of the connections and the respective wire connections to transfer power from external power source to the electrical contacts on the glass at the top and bottom hinges.

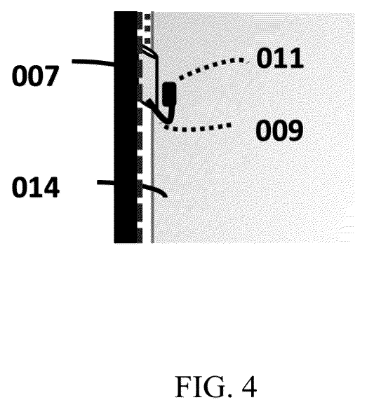

FIG. 4 illustrates the conducting electrical contacts on the top glass door hinge. The glass or similar substrate is coated with an isolated or inner electrical conductive layer. The electrical conductive layer makes the glass to act as conduit between the hinge contact and the electrical connections present at the smart lock.

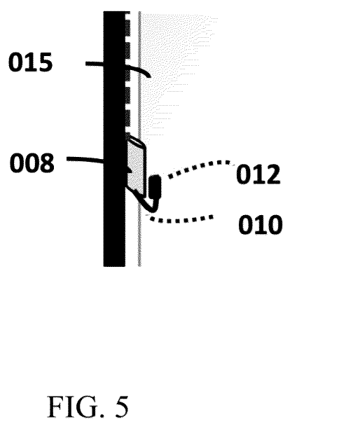

FIG. 5 illustrates the conducting contacts on the bottom glass door hinge. The glass or similar substrate is coated with an isolated or inner electrical conductive layer. The electrical conductive layer makes the glass to act as conduit between the hinge contact and the electrical connections present at the smart lock.

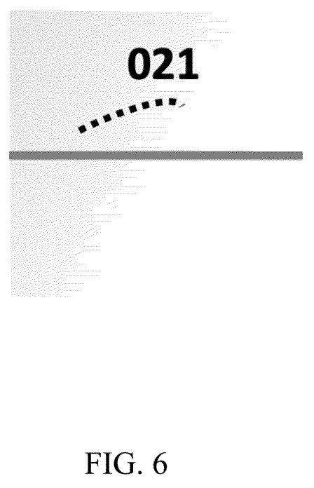

FIG. 6 illustrate an electrical isolation between the two electric pathways to the electric hardware attached to the glass. The glass may have additional treatments to provide necessary isolation arrangement to protect the complete glass from being conducting and providing electrical isolation and safety to any person touching the glass and using the overall hardware.

The isolation provided is to protect the glass from being electrically conducting, while a user is accessing the handle of the smart lock or the hardware attached to the glass.

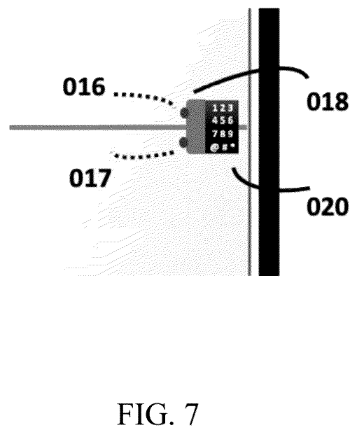

FIG. 7 illustrates the smart lock connected or embedded to the glass panels and interlayers, if any. A keypad based or IOT based or biometric based smart lock can be attached to the glass panel and related hardware.

In another embodiment, the smart lock embedded to the glass panels also allows remote operation and powering as the wires or the electrical assembly is not mounted close to the smart lock. This makes the whole look sleek, not bulky.

The inventive feature of the invention is making the glass panels to act as conduit for the electrical current, or power or electricity to flow and power and operate the smart lock and electrical hardware as discussed above to open and close the door or similar arrangement.

However, the current invention is not limited to a smart lock. A similar hardware with plurality of sensors can be attached to the similar glass panels, doors, windows and as such, which requires electrical powering.

The electronics-based hardware may comprise a small battery for emergency operation, in case of power lost and power failure.

The smart lock is taken as an example to briefly describe the invention. However, this cannot be treated as a limitation to the current invention.

There are variations to the above invention, which are such as all or some of the surfaces in the laminated glass construction or only a few selective surfaces can act as electrical channels. Example: Inner surfaces of a laminated glass construction used as electrical connectors or there can be a number of electrical channels on the inside surface of the laminated glass to act as a number of electrical conduits or channels.

The invention provides a method and system for establishing an electrical connection or path for transmitting sensor signals or monitoring data. The electrical connection/path can be established through a variety of means, including wires, cables, and wireless transmission. The system allows for reliable and efficient transmission of data for a variety of applications, including monitoring and control systems, sensor networks, data management and data acquisition systems.

In Case 1, the scribing process selectively removes material from the surface, creating grooves or new channels that serve as individual pathways for electricity flow. This approach allows for the creation of multiple electrically isolated pathways on a single conducting surface, which can be used to improve the performance and reliability of electronic devices. By selectively removing material, the scribing process creates grooves or channels that act as individual pathways for electricity flow, allowing for increased flexibility in the design of electronic circuits and devices. This approach can be used in various applications, such as display technology, touch screens, sensors, and electronic circuitry, among others.

In Case 2, the scribing process selectively removes conductive material from the surface, creating grooves or channels that serve as individual pathways for isolating electricity flow. This approach allows for the creation of multiple electrically isolated pathways on a single conducting surface, which can be used to reduce the risk of short-circuits and other electrical interference. By selectively removing conductive material, the scribing process creates grooves or channels that act as barriers or insulators, preventing electricity flow between adjacent pathways.

This approach can be used in various applications, such as electronic circuitry, sensors, and other devices where isolating electrical signals is necessary. The pathways could be on the same surface or on different surfaces. For example, the pathways for electricity flow could be on two different substrates of a laminated glass piece where at least two glasses are separated by at least one layer of PVB or EVA, TPU or CIP material. (Polyvinyl butyral (PVB); Ethylene-vinyl acetate (EVA); Thermoplastic polyurethane (TPU); Cast in place (CIP) liquid resin).

An electronics-based hardware integrated in a glass panel, whereas the electronics-based hardware comprising at least two conductive interlayers selected from a plurality of electrically conducting interlayers embedded in the glass, wherein at least two conductive interlayers are electrically isolated and utilized as electrical conduits to supply power to the electronics-based hardware, a communication network is configured to transmit and receive the data collected to a remote server or a cloud; and an artificial intelligence based neural network is embedded in the smart lock, to collect the usage pattern and utilized it for training and enable remote access.

The electronics-based hardware can be a smart lock or any other appliance.

The electronics-based hardware comprises a small battery for emergency operation.

The electronics based hardware comprises the glass, which is configured to provide electro-magnetic radiation free environments to the occupants.

The circuit designs can act itself as antennas for various applications such as power transmission and data communication using signal transmission and amplification.

In both cases, the scribing process can be performed using laser technology or manual techniques, such as diamond scribing or mechanical scribing or chemical processes. Both techniques can be used to create precise and intricate patterns on the conducting surface, allowing for increased flexibility in the design of electronic circuits and devices. Additionally, the conducting surface can be made of various materials, such as glass, PET, ceramics, polymers or similar materials, and may or may not have a topcoat or ceramic coating. This makes the invention suitable for a wide range of applications and industries.

The surface of the glass and other substrates can also be selectively coated with various electrical conductive materials such as ITO, FTO, PEDOT to name a few to create the desired and electrically separated conductive surfaces.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Thus, given the wide variety of configurations and arrangements of embodiments of the present invention the scope of the invention is reflected by the breadth of the claims below rather than narrowed by the embodiments described above.

What is claimed is:

1. A smart lock system comprising:
At least one glass panel having the smart lock;
a plurality of electrically conducting interlayers embedded in a glass to power the smart lock, wherein at least two conductive interlayer selected from the plurality of conducting interlayers are electrically isolated and utilized as electrical conduits to supply power to the smart lock.

2. The smart lock system of claim 1, wherein the plurality of electrically conducting interlayers are the transparent or semi-transparent or opaque or reflective electrically conducting interlayers.

3. The smart lock system of claim 1, wherein the glass panel at least one electrically conducting surface on the glass.

4. The smart lock system of claim 1, wherein at least one or more conductive interlayers are the conducive interlayers of the glass operating as electrical channels.

5. The smart lock system of claim 1, wherein the glass panel is selected from a door, a moving partition, a wall, a flat, a curved component, a window, a balustrade, a railing, a room divider, a curtain wall, a storefront, a skylight, a façade or a ceiling.

6. The smart lock system of claim 1, wherein the power is supplied by an external power source through the glass panels.

7. The smart lock system of claim 1, wherein the glass is replaced with other substrates such as flexiglass, polycarbonate, etc.

8. The smart lock system of claim 1, wherein the smart lock further comprises a bio-metric or similar authentication system to authenticate a user.

9. The system of claim 1, wherein the power through the embedded conductive layers is configured to be used for locks, bio-sensors and other electrical means.

10. The system of claim 1, where a communication network is configured to transmit and receive the data collected by the smart lock to a remote server or a cloud.

11. The system of claim 1, where an artificial intelligence based neural network is embedded in the smart lock, to collect the usage pattern and utilized it for training and enable remote access.

12. The smart lock system of claim 1, wherein the glass panel is an electrically conducting glass having wires embedded in the interlayers to carry electricity or power or voltage or current.

13. The smart lock system of claim 1, wherein the at least two conductive interlayers are the conducive interlayers of the glass operating as electrical channels or conduits.

14. The smart lock system of claim 1, wherein the power is supplied by an external power source through the conducting coatings on the glass panels or through wires simply attached to the glass or in the laminate layer(s).

15. An electronics-based hardware integrated in a glass panel, whereas the electronics-based hardware comprising:
at least two conductive interlayers selected from a plurality of electrically conducting interlayers embedded in the glass, wherein at least two conductive interlayers are electrically isolated and utilized as electrical conduits to supply power to the electronics-based hardware;
a communication network is configured to transmit and receive the data collected to a remote server or a cloud; and
an artificial intelligence based neural network is embedded in the smart lock, to collect the usage pattern and utilized it for training and enable remote access.

16. The electronics-based hardware of claim 15, w herein the electronics-based hardware can be a smart lock or any other appliance.

17. The electronics-based hardware of claim 15, wherein the electronic based hardware comprises a small battery for emergency operation.

18. The electronics based hardware of claim 15, wherein the glass is configured to provide electromagnetic radiation free environments to the occupants.
